(19) United States
(12) Patent Application Publication
(10) Pub. No.: US 2007/0053947 A1
(43) Pub. Date: Mar. 8, 2007

(54) Non-toxic molluscicidal, bryophoticidal and algicidal composition

(75) Inventor: Ralph W. Emerson, Bend, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(73) Assignee: FREM BioSciences, Inc.

(21) Appl. No.: 11/222,002

(22) Filed: Sep. 7, 2005

(51) Int. Cl. A01N 25/00; A01N 65/00

(52) U.S. Cl. 424/405; 424/725; 424/727; 424/750; 424/764; 424/745; 424/771; 424/768; 424/770; 424/774; 424/776

(57) ABSTRACT

A non-toxic, environmentally safe and biodegradable composition having molluscicidal, Bryophytocidal and algicidal properties is disclosed.

### BACKGROUND OF THE INVENTION

Terrestrial pulmonate gastropod molluscs, slugs and snails (collectively referred to herein as “molluscs”) are significant crop pests that affect commercial agriculture, horticulture and domestic gardening. Control of these pests can be achieved through physical trapping, physical or chemical barriers, or with chemical controls. Poison chemical baits such as metaldehyde or methiocarb are effective in poisoning slugs, but snails have developed resistance to some of these poison baits. In addition, some poisonous baits biodegrade either very slowly or not at all. In the case of the principal chemical control metaldehyde, when it is sunny and hot, the kill mechanism is desiccation; however under very moist conditions desiccated and apparently dead molluscs can rehydrate and literally come back to life. An even greater disadvantage of the use of metaldehyde and other poisonous baits is the very real health hazard they pose to humans, to mollusc-controlling animals and insects and to pets should they consume or contact the baits or vegetables that have been in contact with the baits.

The botanical division Bryophyta includes the nonvascular plants true mosses, peat mosses and liverworts. Although some mosses are grown for their decorative value, in wet climates they are well known to be quite destructive to wood structures and to roofs by creating gaps that permit the passage of moisture. In addition, moss on walkways presents a potential safety hazard by creating a slippery surface.

Although some forms of algae such as seaweed are edible and deemed by some to be a delicacy, the growth of algae on walkways in wet climates also poses significant safety hazards by creating a slick surface. And some forms of algae excrete toxins that are life-threatening to both mammals and aquatic life forms, such as cyanobacteria, the so-called “blue-green algae,” which thrives in and pollutes water bodies, which in turn pollute low-lying ground and turf the water bodies contact.

The control of moss and algae is primarily effected by the application of synthetic non-biodegradable chemicals, which of course carries with it health hazards to humans, animals and pets and the potential unwanted destruction of nearby non-targeted plants.

For the reasons noted above, there is a need for a means that controls molluscs, that poses no dangers to humans, pets, or to the environment, and that is biodegradable.

Similarly, there is a need for a means of controlling and preventing the growth of moss and algae that is safe for humans, animals and the environment, and that is biodegradable.

These needs and others which will become apparent to one of ordinary skill, are met by the present invention, which is summarized and described in detail below.

### BRIEF SUMMARY OF THE INVENTION

There are several aspects of the invention.

In a first aspect, the invention provides a nontoxic, environmentally safe and biodegradable composition of matter that has utility at least as a mollusc antifeedant composition, a molluscicide, a mollusc repellant, a Bryophyticide and as an algicide.

In a second aspect, the invention provides a molluscicide that is nontoxic, environmentally safe and biodegradable.

In a third aspect, the invention provides a mollusc repellant that is nontoxic, environmentally safe and biodegradable.

In a fourth aspect, the invention provides a Bryophytocidal composition that is nontoxic, environmentally safe and biodegradable.

In a fifth aspect, the invention provides a nontoxic and environmentally safe method of killing and preventing the growth of moss.

In a sixth aspect, the invention provides an aglicide that is nontoxic, environmentally safe and biodegradable.

In a seventh aspect, the invention provides a nontoxic and environmentally safe method of killing and preventing the growth of algae.

The foregoing compositions can be prepared in a liquid or dry form. Liquid extracts maybe used in liquid formulations, with an aqueous or vegetable oil carrier, or they may be used in dry formulations with the liquid extract being mixed with or adsorbed onto a solid carrier such as a clay or a diatomaceous earth. Dry extracts may be used in dry formulations and applied on or around plants or in the soil around plants. Alternatively, dry extracts can be used in liquid formulations by dissolving or dispersing the extract in a vegetable oil-based carrier.

In addition to the extract and the carrier, liquid formulations may also include one or more gum or gum-like materials that promote the adherence of the composition to plant surfaces or other surfaces of interest.

The compositions can be applied either directly to plants to prevent mollusc feeding or in the vicinity of plants or in the soil around plants to prevent molluscs infestation of a given area. Further, the composition, when used in concentrations in the range of from about 0.01 to about 90 wt %, preferably from about 0.01 to about 20 wt %, more preferably from about 0.1 to about 5 wt %, and most preferably from about 1 to about 3 wt %, may be used as a molluscicidal agent that is fatally toxic to molluscs and to their eggs. Lower concentrations may require multiple applications to achieve the desired molluscicidal effect. The molluscicidal embodiment of the invention can be applied on or around plants or in the soil around plants where mollusc infestation is to be prevented.

The compositions can also be applied either directly to moss or algae when Bryophytocidal or algicidal activity is indicated, or to areas where the prevention of moss or algae growth is desired.

The foregoing and other objectives, features, and advantages of the invention will be more readily understood upon consideration of the following detailed description of the invention taken in conjunction with the accompanying drawings.

### DETAILED DESCRIPTION OF PREFERRED EMBODIMENTS

As used in the specification and claims, the term “about” means the specified value+10% of that value.

The invention comprises a composition that may be applied to or around living plants to serve as a molluscicide and/or a mollusc repellant that prevents molluscs from feeding upon living plant tissue. The composition also serves as both a Bryophitocide and an algicide, as well as preventing the growth of those two plant species. The composition may be in liquid form, or it may be a powder soluble or dispersable in a liquid carrier. Alternatively, the composition may be used in particulate or powdered form, with particle sizes ranging from about 1 to about 25 μm.

The composition is especially effective against terrestrial molluscs, which include those from the genera Ariolimax, Arion, Boettgerilla, Derocera, Limax, Helix, Lehamannia, Prophysaon, Mariaella, Vaginulus, Parmarion, Milax, Veronicella, Cepaea, Oxychilas, Radix, Bradybaena, Subulina, Xestina, Theba, and Opeas.

Broadly stated, the composition of the present invention comprises the following two ingredients: (a) one or more vegetable oils selected from a drying oil and a semi-drying oil and (b) one or more ingredients selected from Quijalla saponin (from the Chilean Soapbark tree), a vegetable oil, plant-derived edible fats and oils and cellulosic materials. In general such ingredients are exempted from regulation by 40 CFR 180.950(b).

As to ingredient (a) of the composition, as used herein, the term “vegetable oil” refers to those oils primarily composed of glyceryl esters in the form of triglycerides of saturated and unsaturated carboxylic acids, classified as “drying” oils, “semi-drying” oils and “non-drying” oils, based upon the degree of unsaturation. In general terms, “drying oils” tend to be highly unsaturated, with an iodine value of from about 140 to about 180, while “semi-drying oils” are not as highly saturated, with an iodine value of from about 90 to about 140. Exemplary such oils include the oils of the cedar, cinnamon, citronella, cottonseed, geranium, hempseed, lemongrass, linseed, Meadowfoam seed, mint, poppy, rosemary, tung and walnut. Most of such oils are included on the U.S. Environmental Protection Agency's List 25B as posing a reduced risk to the health of humans and therefore are exempt from federal regulation. All such oils may also be used in the form of seed meal, which is merely comminuted seed from the plants in question.

Meadowfoam (Limnanthes alba) seed oil is harvested from the seeds of the Meadowfoam plant's white blossoms and is found principally in the Willamette Valley in Oregon. The oil is highly resistant to oxidation, has an iodine value of 86 to 96, and is commercially available from Natural Plant Products of Salem, Org.

As to ingredient (b) in the above composition, Quijalla saponin is commercially available from DanCo, Inc. of Pine Valley, Calif. and is found on EPA List 4A, meaning it is also deemed sufficiently safe that it is exempt from federal regulation. Vegetable oils suitable for use as ingredient (b) include one or more of the following oils: canola, linseed, palm, rice bran, wheat, wintergreen and hydrogenated rapeseed. All such oils are also listed in EPA List 4A.

In a preferred embodiment ingredient (a) is linseed oil and/or Meadowfoam seed oil, and ingredient (b) is Quijalla saponin.

In a preferred embodiment, the two ingredients are present in the following amounts: (a) from about 0.01 to about 20 wt %; and (b) from about 0.01 to about 20 wt %.

In a more preferred embodiment, the aforesaid ingredients are present in the following amounts: (a) from about 0.1 to about 5 wt %; and (b) from about 0.1 to about 5 wt %.

Most preferably, the aforesaid ingredients are present in the following amounts: (a) from about 1 to about 3 wt %; and (b) from about 1 to about 3 wt %.

The foregoing compositions of the invention preferably constitute a concentrate which is then diluted 10 to 20× for application with water (in liquid form) or with a carrier or dispersant of the type noted herein (in dry form).

The composition is preferably present at concentrations of 10 to 20 wt % as a repellant, and at least about 0.1 wt % when used as a molluscicide. When used as a Bryophytocide, the composition should be present in a concentration of from about 5 to about 50 wt %, and in a concentration of from about 0.2 to about 15 wt % when used as an algicide.

Preferably, the composition also includes various formulation-enhancing additives. Thus, the composition may also comprise an attractant such as sucrose, a gum or gum-like agent which enhances the composition's adherence to plant tissue, an antifreezing agent, a preservative such as ascorbic acid or sodium benzoate and a surfactant. Preferably, such agents are nontoxic to humans and animals. Optionally, the composition may include one or more antioxidants and/or UV protectors. Nontoxic water-resisting agents may also be included to enhance the rain fastness of the composition.

Carriers and dispersants which can be used with solid forms of the inventive compositions include clays such as bentonite clays, kaolinite clays, diatomaceous earths and lignosulfonates. Carriers and dispersants typically make up from about 25 to about 95 wt % of a solid formulation.

One preferred additive is a gum or gum-like component to enhance adherence of the composition to the plant. The gum component may include gums such as guar gum, xanthan gum, elemi tree gum and acacia gum. Additional gum-like materials and binders which may be used include bentonite clay, kaolinite clay, and magnesium aluminum silicate. Gels such as gelatin, hydroxypropyl methylcellulose (HPMC), and agar may be used as well. In the event toxicity is not an issue, acrylate-, latex-, and silicon-based adhesives may be used to promote adherence. A single gum or gum-like material may be used, or mixtures of such materials may be used. The gums typically are used in the composition in the range of from about 0.01 to about 5 wt %, preferably from about 0.1 to about 1.0 wt %.

Among the most preferred gums and gum-like materials are xanthan gum, acacia gum, gelatin, and HPMC. An example of a suitable acacia gum is Gum Arabic, available from Al-Don Chem. Inc. Exemplary xanthan gums include Kelzan S (Kelco Co.) and Rhodopol 23 (R. T. Vanderbilt Company). An exemplary HPMC is Methocel K4M (Dow Chemical), and an example of a commercially available gelatin is 300-bloom gelatin (Sigma Chemical).

Nontoxic antioxidants and UV protectors may also be added to the composition of the invention at from about 0.02 to about 3 wt %. Exemplary such antioxidants include ascorbic acid and Vitamin E. Exemplary UV protectors include PABA and derivatives thereof.

In one embodiment it may be useful to include within the composition waterproofing agents at concentrations of from about 0.05 to about 10 wt %, in order to enhance the rain fastness of the composition to the plant or other surface to which it is applied. Such agents may be particularly useful in situations where relatively large amounts of rainfall and/or irrigation are expected. Exemplary waterproofing agents are xanthan gum, and acacia gum.

Antifreezing additives include glycerol, propylene glycol, ethylene glycol, and isopropyl alcohol, and may be present in a concentration ranging from about 1 to about 25 wt %.

As noted above, the composition of the invention may be applied to plants as a liquid, or as a powder. A liquid composition may be applied directly to plant tissue by spraying, or by other means, to wet the plant sufficiently until runoff occurs. The composition need not be applied to plant surfaces, but may be applied to non-plant surfaces as well to serve as a barrier and/or trap for molluscs. Since the composition is mollusc ovicidal as well, it may be dispersed in the soil around plant. When used in powdered form the composition may be applied to moist plant surfaces to provide a light, even coat of powder. The dry formulation may also be used on non-plant surfaces, to serve as a trap and/or barrier to prevent the molluscs from coming in contact with plants.

The invention is further described by the exemplary formulations identified in the Examples below.

### EXAMPLE 1

Formulation 1 of the inventive composition was prepared as follows. Meadowfoam meal (2 wt %) and Quijalla saponin (2 wt %) were mixed well with pelletized corn fiber (96 wt %).

### EXAMPLE 2

Formulation 2 consisted of 0.5 wt % linseed oil and 0.2 wt % Quijalla saponin absorbed onto pelletized corn fiber carrier, and was prepared by mixing 5 g linseed oil with 2 g Quijalla saponin and then adding this mixture to one liter of deionized water and thoroughly stirring. This liquid mixture was then sprayed onto the carrier to make up a total composition concentration of 6 wt %.

### EXAMPLE 3

Formulation 3 consisted of 0.5 wt % linseed oil and 0.2 wt % Quijalla saponin, balance water, and was prepared as in Example 2 with the exception that it was not sprayed onto a carrier.

### EXAMPLE 4

Formulation 4 consisted of 3.0 wt % linseed oil and 0.2 wt % Quijalla saponin, balance water and was prepared by mixing 30 g linseed oil and 2 g Quijalla saponin, then adding this mixture 970 mL of deionized water and thoroughly stirring.

### EXAMPLE 5

Formulation 5 consisted of 2.0 wt % linseed oil and 0.2 wt % Quijalla saponin, balance water and was prepared in substantially the same manner as in Examples 3-4.

### EXAMPLE 6

Formulation 6 consisted of 1.0 wt % linseed oil and 0.2 wt % Quijalla saponin, balance water and was prepared as in Examples 3-4.

### EXAMPLE 7

Formulation 7 consisted of 3.0 wt % linseed oil and 0.3 wt % Polysorbate 20 (Tween 20 from ICI Surfactants of Belgium), balance water and was prepared as in Examples 3-4.

### EXAMPLE 8

Formulation 8 consisted of 3.0 wt % linseed oil and 0.3 wt % Quijalla saponin, balance water and was prepared as in Examples 3-4.

### EXAMPLE 9

Formulation 9 consisted of 8 wt % linseed oil and 2 wt % Meadowfoam oil, 2 wt % Quijalla saponin, balance water to 500 mL, and was prepared in substantially the same manner as in Examples 3-4.

### EXAMPLE 10

Formulation 10 consisted of 0.5 wt % each of linseed oil and Meadowfoam oil and 1.0 wt % Quijalla saponin, balance water and was prepared as in Examples 3-4.

### EXAMPLE 11

Field cages were constructed of four 4×4×1 ft. fiber boards nailed together to form a four-sided enclosure. The open bottom of the enclosures rested over sandy loam soil. Shade was provided by a screen lid with a 70% sunlight block fit over the top of each enclosure. The soil within the entire enclosure was periodically moistened with a fine mist of water emitted from an overhead sprinkler. Approximately 1/12 of an inch of water was applied each day. This allowed the soil to remain consistently damp with no standing water. A harborage consisting of a mason slab on two bricks was placed on the soil in the center of the enclosure, which served as a refuge for the snails during the heat of the day. Eight petunia plants were planted in each enclosure as a food source.

Brown garden snails were obtained from a local commercial snail farm. Snail age varied from 6 months to 1 year old. All snails were healthy and active at the time of release. Twenty-five snails were released into each enclosure and allowed to move freely over the soil surface. Formulation 1 (in dry pellet form) was sprinkled uniformly in each enclosure at a rate equivalent to 1 lb/2000 ft². Evaluations of snail mortality were conducted at 1, 3, 7, 10, and 14 days after treatment (DAT). Surviving snails were then removed and a second batch of 25 snails was introduced. Mortality of the second batch of snails was assessed at 15, 17, 21, and 28 DAT. Feeding damage to the plants and presence or absence of mold growing on the bait was assessed at 7, 14, 21 and 28 DAT.

Snail mortality and percent plant consumption was analyzed using LSD, CV, and Duncan's New Multiple Range Test (p=0.05) using Gylling's Agriculture Research Manager Program.

Formulation 1 was effective against the two batches of snails, causing 5% mortality within 24 hours. Mortality increased to 32% at 3 DAT, and continued to increase to 43, 49, and 58% at 7, 10, and 14 DAT, respectively. For comparison, Ortho Bug-Geta® containing metaldehyde as the active ingredient was applied to a set of four field cages according to the same protocol as used for Formulation 1, and was similarly effective against the two batches of snails, causing 6% mortality at 1 DAT, and increasing to 33, 47, 51 and 55% at 3, 7, 10 and 14 DAT, respectively. As a control, one set of four field cages was left untreated; total mortality in those field cages was 5%.

Formulation 1 and Ortho Bug-Geta® were similarly effective in providing significant protection to the petunia plants. The snails in the Formulation 1-treated plots consumed 11.3% of the plants, compared to 10% in the Ortho Bug-Geta® treated plots. The snails consumed 61.3% of the plants in the untreated plots.

### EXAMPLES 12-13

For Example 12, Formulation 2 in powder form was tested as in Example 10. Application was equivalent to 2 lbs/acre, sprinkled uniformly throughout each field cage.

For Example 13, Formulation 3 in liquid form was tested as in Example 10, applied at an equivalent rate of 60 gals/acre. The spray was directed at the snails as well as throughout the field cage.

For comparison, Corry's Liquid (metaldehyde active ingredient) was applied following the label directions of drops placed 4 to 6 inches apart throughout a third set of four field cages. As a control, a fourth set of four field cages was treated with water only.

Snail mortality was analyzed as in Example 10 and the results are shown in Table 1. Plant damage was also assessed at 7 and 14 DAT, and the results are also shown in Table 1. Formulation 2 provided an average of 80% mortality within 14 days, and Formulation 3 provided an average of 63% mortality within the same period. Plant damage in areas treated by Formulations 2 and 3 was minimal, averaging 0.6%. All plants in the untreated field cage were completely consumed.

TABLE 1

| | | % Mortality | | | | | |
|---|---|---|---|---|---|---|---|
| Example | | 1 | | | | % Plant Damage | |
| No. | Plot | DAT | 3 DAT | 7 DAT | 14 DAT | 7 DAT | 14 DAT |
| 12 | 102 | 20 | 56 | 72 | 88 | 2.5 | 0.6 |
| | 201 | 24 | 52 | 64 | 84 | | |
| | 302 | 16 | 36 | 76 | 96 | | |
| | 404 | 12 | 28 | 40 | 52 | | |
| Mean | | 18 | 43 | 63 | 80 | | |
| 13 | 101 | 52 | 72 | 76 | 80 | 3.6 | 0.6 |
| | 203 | 24 | 28 | 36 | 44 | | |
| | 304 | 20 | 24 | 32 | 40 | | |
| | 401 | 36 | 64 | 76 | 88 | | |
| Mean | | 33 | 47 | 55 | 63 | | |
| Corry's | 103 | 96 | 100 | 100 | 100 | 0 | 0 |
| | 202 | 88 | 92 | 100 | 100 | | |
| | 303 | 84 | 84 | 92 | 100 | | |
| | 402 | 56 | 84 | 92 | 100 | | |
| Mean | | 81 | 90 | 96 | 100 | | |
| Untreated | 104 | 12 | 12 | 12 | 12 | 60 | 100 |
| | 204 | 0 | 0 | 0 | 0 | | |
| | 303 | 0 | 0 | 0 | 0 | | |
| | 402 | 0 | 0 | 0 | 0 | | |
| Mean | | 3 | 3 | 3 | 3 | | |

### EXAMPLES 14-16

For Example 14, Formulation 4 was used as both a molluscicide and a mollusc repellant against 10 brown garden snails in three ways: (1) directly spraying both the snails and food substrate; (2) directly spraying snails only; and (3) spraying food substrate only using the following protocol.

(1) Lettuce leaves were placed in three 6-liter plastic tubs and 10 snails were placed on the leaves in each tub. Both the snails and lettuce leaves in each tub were directly sprayed with 5 ml of Formulation 4 from a hand-pump sprayer. The snails were then examined for mortality at 18, 24 and 32 hours after treatment (HAT) and the % mortality examined.

(2) Three groups of 10 snails were directly sprayed with 5 ml of Formulation 4, taking care that the snails' mucous surfaces were wetted. After spraying, the three groups of snails were placed on untreated lettuce leaves in three separate 6-liter plastic tubs. Mortality was determined at 18, 24 and 32 HAT and the % mortality averaged.

(3) Three potted Marigold plants were sprayed with Formulation 4 sufficiently to cause runoff. Ten snails were placed in each of the three pots and the pots were placed in 6-liter plastic tubs with inverted tubs used as lids to prevent snails from escaping. Snail mortality and leaf damage was assessed daily for four days. As a control, three potted Marigold plants, each with 10 snails, were left untreated.

With respect to treatments (1) and (2), the snails immediately reacted to being sprayed, producing foam. As to treatment (3), no snail mortality was observed, but the snails avoided the sprayed foliage. Plant damage was assessed 4 DAT. By comparison, the foliage on all three of the untreated plants was completely consumed. The results of the above tests are reported in Table 2.

For Example 15, Formulation 5 was used in the same three ways as in Example 14. Substantially the same results for Example 14 treatment (3) and untreated plants were observed. Results are also reported in Table 2.

For Example 16, Formulation 6 was used in the same three ways as in Example 14. Substantially the same results for Example 14 treatment (3) and untreated plants were observed. Results are reported in Table 2.

TABLE 2

| | | | 24 HAT | 32 HAT | 4 DAT |
|---|---|---|---|---|---|
| | Treatment | 18 HAT | Mean % | Mean % | % Plant |
| Example No. | Type | Mean % Dead | Dead | Dead | Damage |
| 14 | 1 | 63.3 | 73.3 | 100 | |
| | 2 | 40.0 | 46.7 | 46.7 | |
| | 3 | 0 | 0 | 0 | 0 |
| 15 | 1 | 76.7 | 80.0 | 93.3 | |
| | 2 | 10.0 | 20.0 | 20.0 | |
| | 3 | 0 | 0 | 0 | 0 |
| 16 | 1 | 60.0 | 60.0 | 73.3 | |
| | 2 | 36.7 | 46.7 | 46.7 | |
| | 3 | 0 | 0 | 0 | 0 |

### EXAMPLES 17-18

For Example 17, 24 tiger slugs were collected from the field and placed in a moist earthen environment for 24 hours to adjust from the trauma of capture. Sixteen of the collected slugs were randomly selected and then placed in 16 separate containers with lids, one slug to a container. Formulation 7 was sprayed directly on each slug with a single spray from a hand-held sprayer. To allow the slugs an opportunity to feed, food in the form of freshly shredded carrots was introduced to each container after the spray application. Mortality was checked at 30 minutes and at 24 hours.

As controls, an aqueous solution of 0.3 wt % of the surfactant Polysorbate 20 (Control 1) and plain water (Control 2) were applied using the same protocol

For Example 18, Formulation 8 was applied to slugs and a food supply was provided as in Example 17. Results are reported in Table 3.

TABLE 3

| | |
|---|---|
| | Percent |
| Example | Mortality |

| No. | 30 min. | 24 hours |
|---|---|---|
| 17 | 100 | 100 |
| 18 | 100 | 100 |
| Control 1 | 0 | 0 |
| Control 2 | 0 | 0 |

### EXAMPLE 19

Formulation 9 was sprayed in 15 mL aliquots onto six separate patches of moss (Brachythecium Albicans) and the moss was checked for phytotoxicity at 24 hours following application. As a control, six different patches of the same moss were sprayed with the same amounts of plain water. The results are shown in Table 4.

TABLE 4

| | Percent Phytotoxicity |
|---|---|
| Example No. | after 24 hours |
| 19 | 100 |
| Control | 0 |

### EXAMPLE 20

An algicidal field test was conducted by the application of the inventive composition to patches of the blue-green algae Plasmodium spp. Grown on cellulosic substrates and to Bermuda grass and evaluated as to degree of penetration, algicidal properties and phytotoxicity.

Specifically, three applications of Formulation 10 (4 mL each) were made on the same day one hour apart to four 8″-square patches of each of the supported algae and grass, Daconil® (a commercially available algicide) was applied in the same manner, as was water (as a control). Degree of penetration of the algae-containing substrates to a depth of about 2″ was assessed by visual observation. Algicidal activity was assessed by the algae drying out and turning a yellow brown color. Phytotoxicity to the grass was assessed by looking for any patches of brown, dry grass. The results are shown in Table 5.

TABLE 5

| Treatment | Algicidal | Penetration | Phytotoxic |
|---|---|---|---|
| Formulation 10 | Yes | yes | no |
| Daconil ® | yes | no | no |
| Water | No | no | no |

### EXAMPLE 21

An ovicidal study was conducted on eggs of the snail Helix aspera.

For Test A, Formulation 11 (2 wt % linseed oil, 1 wt % Quijalla saponin, balance water) was sprayed until runoff directly onto 4 batches of 8 eggs each, then placed on Whatman filter paper and placed in 4 separate Petri dishes. Viable eggs are ivory-colored and generally spherical; non-viable eggs become discolored and deformed. The egg batches were wet daily with 2 mL of water for 20 days and checked for viability at 1, 7, 14 and 21 DAT and averaged.

For Test B, Formulation 11 was also sprayed until saturation onto 4 Whatman filter papers, which were allowed to dry, then placed in 4 Petri dishes and 4 batches of 8 eggs each deposited onto the filter papers and the same daily watering protocol as in Test A was followed.

As a control, 4 batches of 8 eggs each were placed on Whatman filter paper and sprayed directly with water only and the same daily watering protocol as in Test A was followed. The results are shown in Table 6.

TABLE 6

Average Number Viable Eggs

| Test | 1 DAT | 7 DAT | 14 DAT | 21 DAT |
|---|---|---|---|---|
| A | 8 | 3 | 0.5 | 0 |
| B | 8 | 2.5 | 0.3 | 0 |
| Control | 8 | 7.8 | 7.8 | 7.8 |

The terms and expressions which have been employed in the forgoing specification are used therein as terms of description and not of limitation, and there is no intention in the use of such terms and expressions of excluding equivalence of the features shown and described or portions thereof, it being recognized that the scope of the invention is defined and limited only by the claims which follow.

I claim:

1. A composition of matter comprising the following ingredients:
(a) a vegetable oil selected from the group consisting of a drying oil and a semi-drying oil; and
(b) an ingredient selected from the group consisting of Quijalla saponin, a vegetable oil, a surfactant, plant-derived edible fats and oils, and cellulosic materials.

2. The composition of claim 1 wherein ingredient (a) is an oil selected from the group consisting of the oils of cedar, cinnamon, citronella, cottonseed, geranium, hempseed, lemongrass, linseed, Meadowfoam, mint, poppy, rosemary, tung and walnut.

3. The composition of claim 1 wherein ingredient (b) is a vegetable oil is selected from the group consisting of the oils of canola, linseed, palm, rice bran, wheat, wintergreen and hydrogenated rapeseed.

4. The composition of claim 1 wherein ingredient (a) is at least one of linseed oil and Meadowfoam seed oil and ingredient (b) is Quijalla saponin.

5. The composition of claim 4 wherein said linseed oil and said Meadowfoam seed oil is present as linseed oil meal and Meadowfoam seed meal, respectively.

6. The composition of claim 1 in liquid form.

7. The composition of claim 1 mixed with an inert solid.

8. The composition of claim 1 on an inert solid support.

9. The composition of claim 1 in powdered form.

10. The composition of any of claims 4-9 wherein said ingredients are present in the following amounts:
(a) from about 0.01 to about 20 wt %; and
(b) from about 0.01 to about 20 wt %.

11. The composition of claim 10 wherein said ingredients are present in the following amounts:
(a) from about 0.1 to about 5 wt %; and
(b) from about 0.1 to about 5 wt %.

12. The composition of claim 11 wherein said ingredients are present in the following amounts:
(a) from about 1 to about 3 wt %; and
(b) from about 1 to about 3 wt %.

13. A molluscicidal composition comprising the following ingredients:
(a) a vegetable oil selected from the group consisting of a drying oil and a semi-drying oil; and
(b) an ingredient selected from the group consisting of Quijalla saponin, a vegetable oil, a surfactant, plant-derived edible fats and oils, and cellulosic materials.

14. The molluscicidal composition of claim 13 wherein ingredient (a) is an oil selected from the group consisting of the oils of cedar, cinnamon, citronella, cottonseed, geranium, hempseed, lemongrass, linseed, Meadowfoam, mint, poppy, rosemary, tung and walnut.

15. The molluscicidal composition of claim 13 wherein ingredient (b) is a vegetable oil is selected from the group consisting of the oils of canola, linseed, palm, rice bran, wheat, wintergreen and hydrogenated rapeseed.

16. The molluscicidal composition of claim 13 wherein said ingredient (a) is at least one of linseed oil and Meadowfoam seed oil and ingredient (b) is Quijalla saponin.

17. The molluscicidal composition of claim 16 wherein said linseed oil and said Meadowfoam seed oil is present as linseed oil meal and Meadowfoam seed meal, respectively.

18. The molluscicidal composition of claim 13 in liquid form.

19. The molluscicidal composition of claim 13 mixed with an inert solid.

20. The molluscicidal composition of claim 13 on an inert solid support.

21. The molluscicidal composition of claim 13 in powdered form.

22. The molluscicidal composition of any of claims 16-21 wherein said ingredients are present in the following amounts:
(a) from about 0.01 to about 20 wt %; and
(b) from about 0.01 to about 20 wt %.

23. The molluscicidal composition of claim 22 wherein said ingredients are present in the following amounts:
(a) from about 0.1 to about 5 wt %; and
(b) from about 0.1 to about 5 wt %.

24. The molluscicidal composition of claim 23 wherein said ingredients are present in the following amounts:
(a) from about 1 to about 3 wt %; and
(b) from about 1 to about 3 wt %.
